(19) United States
(12) Patent Application Publication
(10) Pub. No.: US 2014/0044855 A1
(43) Pub. Date: Feb. 13, 2014

(54) CREAMERS AND METHODS OF MAKING SAME

(71) Applicants: Alexander A. Sher, Dublin, OH (US); Jean-Baptiste Bezelgues, Powell, OH (US)

(72) Inventors: Alexander A. Sher, Dublin, OH (US); Jean-Baptiste Bezelgues, Powell, OH (US)

(73) Assignee: NESTEC S.A., Vevey (CH)

(21) Appl. No.: 14/113,161

(22) PCT Filed: Apr. 20, 2012
(86) PCT No.: PCT/EP12/57276

§ 371 Date: Oct. 21, 2013

Related U.S. Application Data
(60) Provisional application No. 61/477,949, filed on Apr. 21, 2011.

(51) Int. Cl. A23C 11/02

(52) U.S. Cl. CPC A23C 11/02
USPC 426/593; 426/601; 426/613; 426/602; 426/594; 426/597

(57) ABSTRACT

Creamers for whitening food products are provided. The creamers can be shelf-stable and aseptic. The creamers can have high whitening capacity and a pleasant mouthfeel. In a general embodiment, the present disclosure provides a creamer including a hydrocolloid, an insoluble divalent salt, a protein, an emulsifier, and an oil. The creamer does not need to include titanium dioxide to provide a whitening effect. The creamer can be a fat-free, liquid creamer including water ranging from about 50% to about 90% by weight.

### BACKGROUND

The present disclosure generally relates to food products. More specifically, the present disclosure relates to creamers for food products such as coffee and tea.

Creamers are widely used as whitening agents with hot and cold beverages, e.g., coffee, cocoa, tea, etc. They are commonly used in place of milk and/or dairy cream. Creamers may come in a variety of different flavors and provide mouthfeel, body, and a smoother texture.

Creamers can be in liquid or powder forms. One disadvantage of powder forms is that they do not generally provide an impression of traditional dairy creamers. Another disadvantage of using powder creamers may include difficulties in dissolution when added to coffee, and also the possibility of having a non-homogeneous beverage.

Fresh or refrigerated dairy, liquid whiteners usually provide good mouthfeel. However, they are unacceptable for people with dairy intolerance. They are also inconvenient to use due to short storage capabilities. Moreover, liquid dairy creamers deteriorate rapidly even under refrigeration conditions.

The market of non-dairy creamers as coffee whiteners is rapidly growing, and the U.S. is the market leader for this type of product. A desired whitener should be shelf-stable during storage without phase separation, creaming, gelation and sedimentation, and retain a constant viscosity over time. When added to cold or hot beverages such a coffee or tea, the creamer should dissolve rapidly, provide a good whitening capacity, and remain stable with no feathering and/or sedimentation while providing a superior taste.

Beverage creamers with low or no fat content will not give the same whitening effect when added, for example, to coffee compared to a creamer with a normal fat content. This is often compensated for by adding titanium dioxide (“TiO₂”), which is a very effective whitening agent. Because TiO₂ is widely used as a pigment to provide whiteness and opacity to products such as paints, coatings and plastics, its presence in food and beverages may have an undesirable perception. Moreover, the use of TiO₂ can affect production equipment performance due to it strong abrasive properties. Due to its high density, TiO₂ can also cause cleaning issues due to precipitation in pipes and machinery. As a result, there is a desire to replace TiO₂ with materials that are perceived as being more natural to avoid the problems associated with TiO₂.

Conventional emulsions and suspensions that form typical creamers are not thermodynamically stable. There is a real challenge to overcome physico-chemical instability issues in the liquid creamers that contain oil and other water insoluble materials, especially for the aseptic ones during long storage times and at elevated temperatures. For example, sedimentation of TiO₂ may cause a decrease of whitening capacity and unacceptable visual appearance due to white layer of the sediment on the bottom of a storage container. Consequently, stable creamers that do not include TiO₂ can be beneficial.

### SUMMARY

The present disclosure relates to creamers for food products and methods of making the creamers. The creamers can be shelf-stable and aseptic or chilled. The creamers can have high whitening capacity and a pleasant mouthfeel. In a general embodiment, the present disclosure provides a creamer including a hydrocolloid, an insoluble divalent salt, a protein, an emulsifier, and an oil. In an embodiment, the creamer excludes TiO₂. The creamer can be an aseptic, liquid creamer including water ranging from about 50% to about 90% by weight.

In an embodiment, the insoluble divalent salt ranges from about 0.1% to about 10% by weight. The insoluble divalent salt can range from about 50 mg to about 500 mg (e.g., per serving). The insoluble divalent salt can be in an amount to provide about up to about 20% of the recommended daily intake of calcium per serving. The insoluble divalent salt can be a calcium salt or magnesium salt such as, for example, calcium phosphate, calcium citrate, calcium carbonate, magnesium carbonate, magnesium hydroxycarbonate or a combination thereof.

In an embodiment, the hydrocolloid ranges from about 0.01% to about 5% by weight. The hydrocolloid can be cellulose, microcrystalline cellulose, carboxy-methyl cellulose, carrageenan (e.g., kappa, iota), agar-agar, cornstarch, gelatin, gellan (e.g., high acyl, low acyl), guar gum, gum arabic, kojac, locust bean gum, methyl cellulose, pectin, sodium alginate, tapioca maltodextrin, tracaganth, xanthan or a combination thereof.

In an embodiment, the protein ranges from about 0.01% to about 5% by weight. The protein can be casein, sodium caseinate, potassium caseinate, calcium caseinate, soy protein, pea protein, whey protein or a combination thereof.

In an embodiment, the emulsifier ranges from about 0.01% to about 5% by weight. The emulsifier can be monoglycerides, succinic acid esters of monoglycerides, diacetyl tartaric acid esters of monoglycerides or a combination thereof. In an embodiment, the emulsifier includes a low hydrophilic-lipophilic balance value emulsifier. In another embodiment, the emulsifier includes a medium hydrophilic-lipophilic balance value emulsifier.

In an embodiment, the oil ranges from about 0.1% to about 10% by weight. The oil can be a vegetable oil such as soybean oil, coconut oil, palm oil, palm oil fractions, cottonseed oil, canola oil, olive oil, sunflower oil, high oleic sunflower oil, safflower oil or a combination thereof.

In an embodiment, the creamer further includes a buffering agent. In another embodiment, the creamer includes an additional ingredient such as flavors, sweeteners, colorants or a combination thereof.

In another embodiment, the present disclosure provides a method of providing a creamer with a whitening effect in the absence of TiO₂. The method comprising combining an insoluble divalent salt with a hydrocolloid, a protein, an emulsifier and an oil in an aqueous solution to form a creamer not containing TiO₂. The insoluble divalent salt can be micronized prior to combining to reduce particle sizes of the insoluble divalent salt. The method can further comprise homogenizing and aseptically processing the creamer.

In an alternative embodiment, the present disclosure provides a consumable product including at least one of a coffee, tea or cocoa and a creamer including a hydrocolloid, an insoluble divalent salt, a protein, an emulsifier and an oil. The creamer of the consumable product can exclude TiO₂. The consumable product can be a coffee beverage including from about 0.1% to about 5% of the coffee in a solution (e.g., 1.2% soluble coffee in water).

In yet another embodiment, the present disclosure provides an aseptic, liquid creamer including a hydrocolloid, an insoluble divalent salt such as calcium phosphate, calcium citrate, calcium carbonate, magnesium carbonate, magnesium hydroxycarbonate or a combination thereof, a protein, an emulsifier, and an oil, wherein the liquid creamer excludes TiO₂.

An advantage of the present disclosure is to provide a creamer having a high whitening capacity without using TiO₂.

An advantage of the present disclosure to provide a creamer having whitening effects and a beneficial amount of calcium or other mineral.

Still another advantage of the present disclosure is to provide a liquid creamer that has a good mouthfeel, body, smooth texture, and a good flavor without off-notes.

Additional features and advantages are described herein, and will be apparent from, the following Detailed Description and the figures.

### BRIEF DESCRIPTION OF THE FIGURES

FIG. 1 shows the whitening capacity of a fat-free liquid coffee whitener in coffee (bench-top trials) containing increasing amounts of calcium carbonate.

FIG. 2 shows the effect of calcium carbonate and calcium phosphate concentrations on whitening capacity of TiO₂ free and fat-free liquid coffee whitener in coffee.

FIG. 3 shows the effect of calcium citrate concentrations on whitening capacity of TiO₂ free and fat-free coffee whitener.

### DETAILED DESCRIPTION

The present disclosure relates to creamers and methods of making the creamers. The creamers can be added to any suitable beverage in an amount sufficient to provide a whitening or creaming effect on the beverage. A creaming effect imparts qualities associated with cream or dairy such as desirable, flavor, texture, body, and/or color (e.g., lightening or whitening).

The creamers in alternative embodiments of the present disclosure can be easily dispersible in coffee and stable in hot and cold acidic environments without one or more of the following problems: feathering, breaking emulsion, de-oiling, flocculation and sedimentation. When added to coffee, tea, cocoa or other liquid products, the creamers can provide a high whitening capacity, a good mouthfeel, full body, smooth texture, and also a good flavor with no off-flavor notes developed during storage time. The creamers can be used with other various food products such as cereals, as cream for berries, creamers for soups or in many cooking applications.

As used herein, the term “stable” means remaining in a state or condition having minimal phase separation (e.g., creaming, sedimentation, age gelation) for an extended period of time (e.g., for at least 1 month). Stable liquid creamers according to embodiments of the present disclosure can be found to be stable when maintained for at least 1 month, and can generally be stable from 2 to 3 months or longer without significant feathering, flocculation, sedimentation issues.

It has been surprisingly found that insoluble divalent salts, for example, present in creamers as small suspended particles can provide a whitening effect similar to TiO₂. As used herein, the insoluble divalent salts are distinguishable from the calcium naturally present in dairy products (e.g., in the form of calcium phosphate-protein complexes). In an embodiment, the creamers exclude calcium phosphate-protein complexes, natural dairy products containing calcium phosphate-protein complexes or natural dairy products (e.g., milk) in general.

In a general embodiment, the present disclosure provides a creamer including one or more hydrocolloids, one or more insoluble divalent salts, one or more proteins, one or more emulsifiers, and one or more oils. In an embodiment, the creamer is fat-free and/or excludes TiO₂. As used herein, the term “fat-free” means containing little (e.g., less than 5%, 4%, 3%, 2%, 1%, etc. fat) or no fat at all. The creamer can be a stable and/or aseptic, liquid creamer including water ranging from about 50% to about 90% by weight.

In another embodiment, the present disclosure provides a method of providing a creamer with a whitening effect in the absence of TiO₂. The method comprising combining an insoluble divalent salt with a hydrocolloid, a protein, an emulsifier and an oil in an aqueous solution to form a creamer not containing TiO₂. The insoluble divalent salt can be micronized prior to combining to reduce particle sizes of the insoluble divalent salt. The method can further comprise homogenizing and aseptically processing the creamer in an appropriate storage container.

In an alternative embodiment, the present disclosure provides a consumable product including at least one of a coffee, tea or cocoa and a creamer including one or more hydrocolloids, one or more insoluble divalent salts, one or more proteins, one or more emulsifiers, and one or more oils. The creamer of the consumable product can exclude TiO₂. For example, the consumable product can be a coffee beverage including from about 0.1% to about 5% of the coffee in a solution.

In yet another embodiment, the present disclosure provides an aseptic or chilled, liquid creamer including one or more hydrocolloids, one or more insoluble divalent salts such as calcium phosphate, calcium citrate, calcium carbonate, magnesium carbonate, magnesium hydroxycarbonate or a combination thereof, one or more proteins, one or more emulsifiers, and one or more oils, wherein the liquid creamer excludes TiO₂. The liquid creamer can be a shelf-stable aseptic, liquid creamer or a chilled creamer. In another embodiment, the aseptic, liquid creamer does not include any natural dairy products such as milk.

In any embodiments of the creamer of the present disclosure, the insoluble divalent salt can range from about 0.1% to about 10% by weight. The insoluble divalent salt can range from about 50 mg to about 500 mg (e.g., per serving). The insoluble divalent salt content can be in an amount to provide about up to about 20% of the recommended daily intake of one or more required minerals, e.g., calcium, per serving. The insoluble divalent salt can be a calcium or magnesium salt such as, for example, calcium phosphate, calcium citrate, calcium carbonate, magnesium carbonate, magnesium hydroxycarbonate or a combination thereof. In an embodiment, the insoluble divalent salts are micronized so as to achieve finer particle sizes for the insoluble divalent salts.

In any embodiments of the creamer of the present disclosure, the hydrocolloid can range from about 0.01% to about 5% by weight. The hydrocolloid can be cellulose, microcrystalline cellulose, carboxy-methyl cellulose, carrageenan (e.g., kappa, iota), agar-agar, cornstarch, gelatin, gellan (e.g., high acyl, low acyl), guar gum, gum arabic, kojac, locust bean gum, methyl cellulose, pectin, sodium alginate, tapioca maltodextrin, tracaganth, xanthan or a combination thereof.

In any embodiments of the creamer of the present disclosure, the protein can range from about 0.01% to about 5% by weight. The protein can be casein, sodium caseinate, potassium caseinate, calcium caseinate, soy protein, pea protein, whey protein or a combination thereof.

In any embodiments of the creamer of the present disclosure, the emulsifier can range from about 0.01% to about 5% by weight. The emulsifier can be monoglycerides, succinic acid esters of monoglycerides, diacetyl tartaric acid esters of monoglycerides or a combination thereof. In an embodiment, the emulsifier includes a low hydrophilic-lipophilic balance value emulsifier. In another embodiment, the emulsifier includes a medium hydrophilic-lipophilic balance value emulsifier.

The hydrophilicity and lipophilicity are different among emulsifiers, and the balance between the two is called the hydrophilic-lipophilic balance HLB value. The HLB value is determined by calculating hydrophilic or lipophilic values of the different regions of the molecule. Various references discuss the HLB value. Examples are Griffin W C: “Classification of Surface-Active Agents by ‘HLB,’” Journal of the Society of Cosmetic Chemists 1 (1949): 311, or Griffin W C: “Calculation of HLB Values of Non-Ionic Surfactants,” Journal of the Society of Cosmetic Chemists 5 (1954): 259, which are incorporated herein by reference. The HLB value of an emulsifier typically ranges from 0 to 20.

Low HLB values range from about 1 to about 5. Medium HLB values range from about 5 to about 10. Low molecular weight emulsifiers with low HLB values can include, but are not limited to, monoglycerides, diglycerides, acetylated monoglycerides, sorbitan trioleate, glycerol dioleate, sorbitan tristearate, propyleneglycol monostearate, glycerol monooleate and monostearate, alone or in combination. The low molecular weight emulsifiers with medium HLB values can include, but are not limited to, sorbitan monooleate, propylene glycol monolaurate, sorbitan monostearate, calcium stearoxyl-2-lactylate, glycerol sorbitan monopalmitate, soy lecithin, canola lecithin, sunflower lecithin, safflower lecithin, and diacetylated tartaric acid esters of monoglycerides, alone or in combination.

In an embodiment, the emulsifiers are monoglycerides (“MG”), diglycerides (“DG”), diacetyl tartaric acid esters of monoglycerides (“TMG”) or a combination thereof having the specified low or medium HLB values. In an embodiment, the weight ratio between MG and DG can be about 7:1 to about 9.5:1, respectively. In another embodiment, the weight ratio between MG and TMG can be about 1:2.5 to about 1:4.5, respectively.

In any embodiments of the creamer of the present disclosure, the oil can range from about 0.1% to about 10% by weight. The oils can provide creaminess and mouthfeel to the creamer. The oils can also participate in the whitening effect of the creamer.

In an embodiment, the oil includes one or more vegetable oils. The vegetable oil can be soybean oil, coconut oil, palm oil, palm oil fractions, cottonseed oil, canola oil, olive oil, sunflower oil, high oleic sunflower oil, safflower oil or a combination thereof. The vegetable oil(s) can include partially or wholly hydrogenated oils, alone or in combination.

The sunflower oil can be high oleic sunflower oil. The oils can be blended in any suitable amount and manner to ensure maximum oxidation stability. For instance, the oil can include a blend of vegetable oils that includes no more than 65% saturated fatty acids. In an embodiment, the blend of vegetable oils includes no more than 1% trans fatty acids.

The oil can be one of the main components of the disperse phase in the emulsion. In an embodiment, the average diameter of the oil droplets is lower than 0.6 microns. Preferably, the oil droplets have a diameter ranging from about 0.25 microns to 0.45 microns. The oil droplets of the emulsion in this range of particle size provide an optimal whitening effect.

In any embodiments of the creamer of the present disclosure, the creamer can further include a buffering agent. The buffering agent can prevent undesired creaming or precipitation of the creamer upon addition into a hot, acidic environment such as coffee. The buffering agent can be, for example, monophosphates, diphosphates, sodium mono- and bicarbonates, potassium mono- and bicarbonates or a combination thereof. More specifically, non-limiting examples of suitable buffers are salts such as potassium phosphate, dipotassium phosphate, potassium hydrophosphate, sodium bicarbonate, sodium citrate, sodium phosphate, disodium phosphate, sodium hydrophosphate, and sodium tripolyphosphate. The buffer can be present in an amount of about 0.5 to about 1% by weight of the liquid creamer.

In any embodiments of the creamers of the present disclosure, the creamer can include one or more additional ingredients such as flavors, sweeteners, colorants or a combination thereof. Sweeteners can include, for example, sucrose, fructose, dextrose, maltose, dextrin, levulose, tagatose, galactose, corn syrup solids and other natural or artificial sweeteners. Sugarless sweeteners can include, but are not limited to, sugar alcohols such maltitol, xylitol, sorbitol, erythritol, mannitol, isomalt, lactitol, hydrogenated starch hydrolysates, and the like, alone or in combination.

Usage level of the flavors, sweeteners and colorants will vary greatly and will depend on such factors as potency of the sweetener, desired sweetness of the product, level and type of flavor used and cost considerations. Combinations of sugar and/or sugarless sweeteners may be used in the liquid creamers. In an embodiment, the sweetener is present in the liquid creamer at a concentration ranging from about 20% to about 50% by weight. In another embodiment, the sweetener ranges from about 25% to about 35% by weight.

During processing and production of the creamer, the hydration of any components of the creamers such as gums, emulsifiers, proteins, buffer(s), sweetener(s) and flavor(s) in water can be done under agitation with the addition of melted oil/fat, followed by heat treatment, homogenization, cooling and filling aseptic containers under aseptic conditions. Aseptic heat treatment may use direct or indirect ultra high temperature (“UHT”) processes. UHT processes are known in the art. Examples of UHT processes include UHT sterilization and UHT pasteurization.

Direct heat treatment is performed by injecting steam water in the emulsion. In this case, it may be necessary to remove excess water, by flashing. Indirect heat treatment is performed with a heat transfer interface in contact with the emulsion. The homogenization could be performed before and/or after heat treatment. It may be interesting to perform homogenization before heat treatment in order to improve heat transfers in the emulsion, and thus achieve an improved heat treatment. Performing a homogenization after heat treatment usually ensures that the oil droplets in the emulsion have the desired dimension. Aseptic filling is described in various publications, such as articles by L, Grimm in “Beverage Aseptic Cold Filling” (Fruit Processing, July 1998, p. 262-265), by R. Nicolas in “Aseptic Filling of UHT Dairy Products in HDPE Bottles” (Food Tech. Europe, March/April 1995, p. 52-58) or in U.S. Pat. No. 6,536,188 B1 to Taggart, which are incorporated herein by reference.

The creamers, when added to a beverage, can produce a physically stable homogeneous whitened drink with a good mouthfeel, and body, smooth texture, and a pleasant taste with no off-flavors notes. The use of the creamers is not limited for only coffee applications. For example, the creamers can be also used for other beverages, such as tea or cocoa, or used with cereals or berries, creamers for soups, and in many cooking applications, etc.

### EXAMPLES

By way of example and not limitation, the following examples are illustrative of various embodiments of the present disclosure.

### Example 1

### Objective

Evaluate the effect of the addition of insoluble calcium salts on the whitening capacity of TiO₂ free coffee whitener/creamer.

### Approaches

The addition of insoluble calcium salts was considered as an alternative to TiO₂ to bring whiteness along with the added nutritional benefit in fat-free coffee whitener of being a “good” or “excellent” source of calcium. The following studies detail the effect of different insoluble calcium salts on the whitening capacity of fat-free coffee whitener without TiO₂.

To develop TiO₂ free coffee whitener without compromising its whitening capacity, the following steps were considered:
1) Replacement of TiO₂ with insoluble calcium salts such as calcium carbonate, calcium phosphate and calcium citrate in fat-free coffee whitener formulas.
2) Bench-top trials using TiO₂ free model systems with added salts at 3 different levels.
3) Measurements of the whitening capacity of new TiO₂ free coffee whitener in coffee.

### Materials

The following were the main ingredients used in the investigation:

Calcium sources:
Calcium carbonate
Calcium phosphate
Calcium citrate

### Oils:

Partially hydrogenated (“PH”) soybean and cottonseed oil

### Hydrocolloid:

Avicel® GP 1417, FMC BioPolymer Inc., USA (Microcrystalline cellulose, CMC)

### Emulsifiers:

Panodan Datem (mono- and di-glycerides), Danisco Inc., USA

### Methods

Preparation of Coffee with coffee whitener: A 1.2% coffee beverage was prepared with instant coffee powder (Taster Choice®, French roasted, freeze dried). Whitened coffee samples were prepared by adding 30 g of fat-free coffee whitener to 180 ml of black coffee at 85° C.

Whitening capacity: Color L, a, and b values of the coffee with coffee whitener were determined using a Colorimeter, Model ColorQuest XE.

Particle size analysis: Malvern, Mastersizer 2000MA was used to determine particle size distribution (water was used as a dispersant).

### Bench-Top Sample Preparation

The coffee whitener samples were prepared on a bench-top using the following procedures:
A variable speed commercial blender (Waring Commercial Blender) attached to a variable autotransformer (Staco Inc., Dayton, Ohio) was used. The blender jar was pre-warmed with hot water.
Hydrocolloid and sugar solids were added to the hot water (75-85° C.) and blended for 4 minutes at speed setting 40.
Disodium phosphate was added to the water and blended for 2 minutes at low speed setting 35.
Sodium caseinate was added and blended for 2 min at speed setting 40.
Datem was added to the vortex of the mix and blended for 3 minutes at speed setting 40.
Melted oil was added to the mix and blended for 3 minutes at speed setting 40.
The batch was homogenized (Niro-Soavi, Italy) at 2000 psi 1st stage and 500 psi 2nd stage (172/35 bar).
The homogenized product was filled and stored in PET bottles.

### Model Systems

Calcium salts were added to creamer MSCa-1, MSCa-2 and MSCa-3 model systems to achieve 5, 10 and 20% of calcium Recommended Daily Intake (“RDI”) per serving, respectively. A model system without an added source of calcium was used as a reference (MSCa-0). Examples of the fat-free coffee whitener (2.4% oil) model system with added calcium carbonate are shown in Table 1 (Water was added to achieve 100% formula).

TABLE 1
Model System Recipe of TiO₂ free, fat-free coffee whitener with
calcium carbonate

| | MSCa-0 | MSCa-1 | MSCa-2 | MSCa-3 |
|---|---|---|---|---|
| water | 68.19 | 67.34 | 66.49 | 64.79 |
| sugar | 28 | 28 | 28 | 28 |
| Soybean oil | 2.4 | 2.4 | 2.4 | 2.4 |
| Disodium phosphate | 0.4 | 0.4 | 0.4 | 0.4 |
| Mono-&di-glycerides (Datem) | 0.4 | 0.4 | 0.4 | 0.4 |
| Avicel GP1417 | 0.31 | 0.31 | 0.31 | 0.31 |
| sodium caseinate | 0.3 | 0.3 | 0.3 | 0.3 |
| calcium carbonate | 0 | 0.85 | 1.7 | 3.4 |
| Total | 100 | 100 | 100 | 100 |

Evaluation of Whitening Capacity of Fat-Free Coffee Whitener Fortified with Calcium

### Effect of Calcium Carbonate

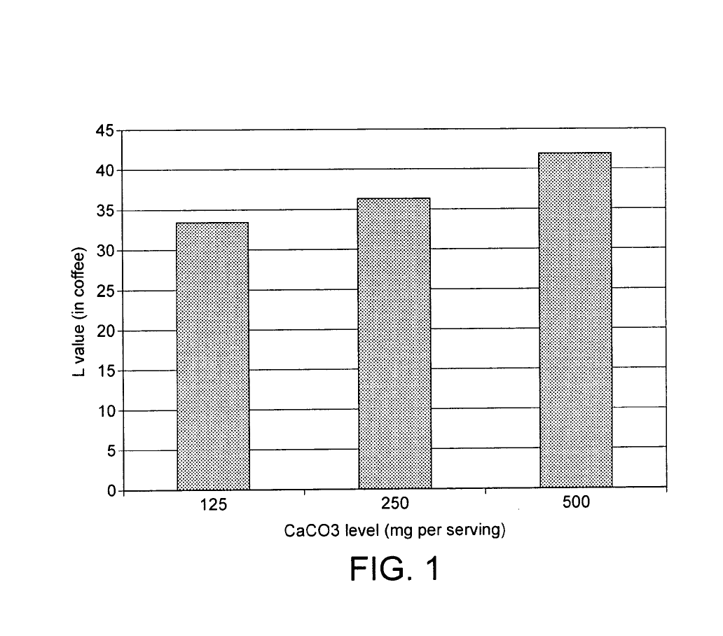

Fat-free coffee whitener model systems without TiO₂ were prepared at bench-top scale. Calcium carbonate powder was added to fat-free coffee whitener in an amount of 125, 250, and 500 mg (as calcium carbonate/15 g serving), which is equivalent to 50, 100 and 200 mg (as calcium/15 g serving), to achieve 5, 10 and 20% RDI, respectively. Products containing 10 and 20% RDI of calcium can be labeled as “good” or “excellent” sources of calcium, respectively. The whitening capacity in coffee (i.e., L value) of the TiO₂ free, fat-free coffee whitener with added calcium carbonate (“CaCO₃”) is shown in FIG. 1.

As seen in FIG. 1, calcium fortified coffee whitener containing 20% RDI (500 mg CaCO₃ or 200 mg Ca/per serving) has a whitening capacity close to the target (L=42-44 for fat-free coffee whitener pilot plant samples). 200 mg Ca/serving corresponds to an addition of 3.4% of calcium carbonate in the recipe. It should be noted that lower L values of the bench-top samples were expected as compared to those of the pilot plant due to lower efficiency of the homogenization equipment as compared to the pilot plant.

### Additional Creamers

The creamers described in the following were produced as above and of similar composition, except for the divalent salts as stated.

### Effect of Calcium Phosphate vs Calcium Carbonate

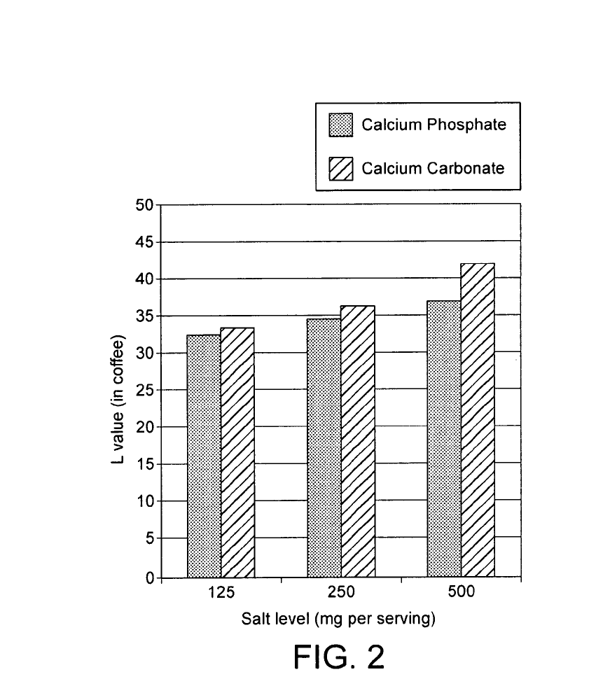

The effect of the salts concentration for calcium carbonate and calcium phosphate on coffee whitener whitening capacity is shown in FIG. 2. A good linear correlation between calcium salt level and fat-free coffee whitener whitening capacity was found for the both salts.

### Effect of Calcium Citrate

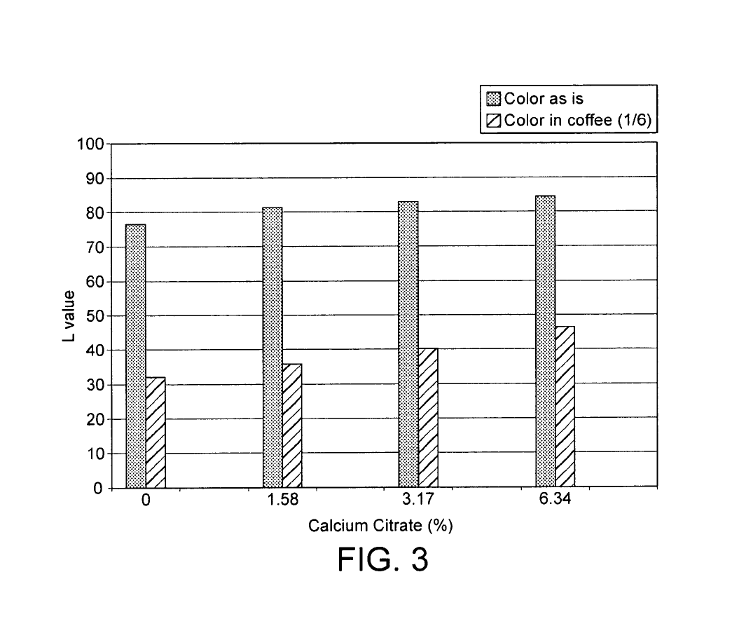

The effect of calcium citrate on the whitening capacity of TiO₂ free coffee whitener (as is) and when added to coffee (in ⅙ dilution) is shown in FIG. 3. Calcium citrate concentrations of ˜1.6, 3.2 and 6.3% in coffee whitener correspond to 5, 10 and 20% of calcium RDI per serving, respectively.

The addition of calcium citrate to achieve 200 mg calcium per serving (20% RDI) resulted in increased whitening capacity of the calcium fortified coffee whitener by 10% (as is), and by 45% when added to coffee at 1 to 6 dilution. At this level of calcium citrate (medium particle size of ˜1.5 microns), whitening capacity in coffee was on target and comparable to a TiO₂ fat-free coffee whitener.

The sensorial evaluation of coffee whitened with bench-top fat-free coffee whitener containing 5, 10, and 20% of calcium citrate (using a small taste panel of 5 people) showed that the addition of calcium citrate has limited or no impact on the beverage taste as compared to that of the reference even at the highest salt level. However, it should be emphasized that due to the high level of calcium citrate (6.3%, w/w) in fat-free coffee whitener, stability of the salt suspension during coffee whitener storage was an issue, which was solved using the hydrocolloid stabilizing system

### Conclusions

Based on the bench-top studies, insoluble divalent salts can be used as a whitener to replace TiO₂ in fat-free coffee whitener. A significant increase in the whitening capacity of coffee whitener can be obtained by increasing the concentration of insoluble salts. However, a significant amount (3.2% for calcium carbonate and 6.3% for calcium citrate) is needed to match the whitening capacity of TiO2 fat-free coffee whitener, which can lead to sedimentation over storage.

A unique hydrocolloid stabilizing system may be required to stabilize the insoluble salt suspension. To further improve fat-free coffee whitener whitening capacity, process improvements (e.g., increasing homogenization pressure) may also be used.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A creamer comprising:
a hydrocolloid;
an insoluble divalent salt;
a protein;
an emulsifier; and
an oil.

2. The creamer of claim 1, wherein the creamer does not include titanium dioxide.

3. The creamer of claim 1, wherein the insoluble divalent salt comprise from about 0.1% to about 10% by weight.

4. The creamer of claim 1, wherein the insoluble divalent salt are present in an amount of about 50 mg to about 500 mg.

5. The creamer of claim 1, wherein the insoluble divalent salt is present in an amount to provide about up to about 20% of the recommended daily intake of calcium per serving.

6. The creamer of claim 1, wherein the insoluble divalent salt is selected from the group consisting of calcium phosphate, calcium citrate, calcium carbonate, magnesium carbonate, magnesium hydroxycarbonate and combinations thereof.

7. The creamer of claim 1, wherein the hydrocolloid comprises from about 0.01% to about 5% by weight.

8. The creamer of claim 1, wherein the hydrocolloid is selected from the group consisting of cellulose, microcrystalline cellulose, carboxy-methyl cellulose, carrageenan, agar-agar, cornstarch, gelatin, gellan, guar gum, gum arabic, kojac, locust bean gum, methyl cellulose, pectin, sodium alginate, tapioca maltodextrin, tracaganth, xanthan and combinations thereof.

9. The creamer of claim 1, wherein the protein comprises about 0.01% to about 5% by weight.

10. The creamer of claim 1, wherein the protein is selected from the group consisting of casein, sodium caseinate, potassium caseinate, calcium caseinate, soy protein, pea protein, whey protein and combinations thereof.

11. The creamer of claim 1, wherein the emulsifier comprises about 0.01% to about 5% by weight.

12. The creamer of claim 1, wherein the emulsifier is selected from the group consisting of monoglycerides, succinic acid esters of monoglycerides, diacetyl tartaric acid esters of monoglycerides and combinations thereof.

13. The creamer of claim 1, wherein the emulsifier comprises a low hydrophilic-lipophilic balance value emulsifier.

14. The creamer of claim 1, wherein the emulsifier comprises a medium hydrophilic-lipophilic balance value emulsifier.

15. The creamer of claim 1, wherein the oil comprises about 0.1% to about 10% by weight.

16. The creamer of claim 1, wherein the oil comprises a vegetable oil selected from the group consisting of soybean oil, coconut oil, palm oil, palm oil fractions, cottonseed oil, canola oil, olive oil, sunflower oil, high oleic sunflower oil, safflower oil and combinations thereof.

17. The creamer of claim 1, further comprising a buffering agent.

18. The creamer of claim 1, further comprising an ingredient selected from the group consisting of flavors, sweeteners, colorants and combinations thereof.

19. The creamer of claim 1, wherein the creamer is an aseptic, liquid creamer comprising water ranging from about 50% to about 90% by weight.

20. A method of providing a creamer with a whitening effect in the absence of titanium dioxide, the method comprising:
combining an insoluble divalent salt with a hydrocolloid, a protein, an emulsifier and an oil in an aqueous solution to form a creamer not containing titanium dioxide.

21. The method of claim 20, comprising micronizing the insoluble divalent salt prior to combining to reduce particle sizes of the insoluble divalent salt.

22. The method of claim 20 further comprising homogenizing and aseptically processing the creamer.

23. The method of claim 20, wherein the insoluble divalent salt comprises about 0.1% to about 10% by weight.

24. The method of claim 20, wherein the insoluble divalent salt comprises about 50 mg to about 200 mg by weight.

25. The method of claim 20, wherein the insoluble divalent salt provides about up to about 20% of the recommended daily intake of calcium per serving.

26. The method of claim 20, wherein the insoluble divalent salt is selected from the group consisting of calcium phosphate, calcium citrate, calcium carbonate, magnesium carbonate, magnesium hydroxycarbonate and combinations thereof.

27. A consumable product comprising
at least one component selected from the group consisting of a coffee, tea and cocoa; and
a creamer comprising a hydrocolloid, an insoluble divalent salt, a protein, an emulsifier and an oil.

28. The consumable product of claim 27, wherein the creamer excludes titanium dioxide.

29. The consumable product of claim 27, wherein the insoluble divalent salt comprises about 0.1% to about 10% by weight.

30. The consumable product of claim 27, wherein the insoluble divalent salt comprises about 50 mg to about 200 mg.

31. The consumable product of claim 27, wherein the insoluble divalent salt comprises about up to about 20% of the recommended daily intake of calcium per serving.

32. The consumable product of claim 27, wherein the insoluble divalent salt is selected from the group consisting of calcium phosphate, calcium citrate, calcium carbonate, magnesium carbonate, magnesium hydroxycarbonate and combinations thereof.

33. The consumable product of claim 27, wherein the consumable product is a coffee beverage comprising from about 0.1% to about 5% of the coffee in a solution.

34. An aseptic, liquid creamer comprising:
a hydrocolloid;
an insoluble divalent salt selected from the group consisting of calcium phosphate, calcium citrate, calcium carbonate, magnesium carbonate, magnesium hydroxycarbonate and combinations thereof;
a protein;
an emulsifier; and
an oil, wherein the liquid creamer does not include titanium dioxide.
